(19) United States
(12) Patent Application Publication
(10) Pub. No.: US 2026/0254877 A1
(43) Pub. Date: Aug. 27, 2026

(54) Decentralized Local Accountless Authorization Gateway for Continuity-Based Service Access Across Heterogeneous User-Interface Nodes

(71) Applicant: ALEXANDER JOHN BRACKEN, DUBAI (AE)

(72) Inventor: ALEXANDER JOHN BRACKEN, DUBAI (AE)

(21) Appl. No.: 19/644,142

(22) Filed: Apr. 10, 2026

Related U.S. Application Data
(63) Continuation of application No. 19/418,946, filed on Dec. 13, 2025.
(60) Provisional application No. 63/913,268, filed on Nov. 7, 2025.
(60) Provisional application No. 63/913,146, filed on Nov. 7, 2025.
(60) Provisional application No. 63/914,032, filed on Nov. 8, 2025.
(60) Provisional application No. 63/921,315, filed on Nov. 20, 2025.
(60) Provisional application No. 63/930,668, filed on Dec. 3, 2025.
(60) Provisional application No. 63/930,661, filed on Dec. 3, 2025.

(51) Int. Cl. H04L 67/306; H04L 9/40

(52) U.S. Cl. CPC H04L 67/306; H04L 63/0861

(57) ABSTRACT

A decentralized authorization system enables continuity-based service access using a continuity anchor device that derives non-invertible continuity tokens from biometric or interaction-derived signals combined with a device-specific secret value. The anchor device generates local authorization requests referencing cryptographic derivatives of the continuity token, validates cryptographic receipts or zero-knowledge proofs using locally stored cryptographic key material, and updates a local time-locked authorization register without requiring persistent user accounts, remote account login, cloud-hosted entitlement validation, or external key escrow. Service access parameters include session duration, memory depth, and cross-device restoration privileges. A similarity metric is evaluated locally at the continuity anchor device prior to authorizing session context restoration. Any remote account login or cloud-hosted entitlement validation is insufficient by itself to authorize service access absent local validation within the continuity anchor device. The system supports offline operation and policy-adaptive compliance modes.

### CROSS-REFERENCE TO RELATED APPLICATIONS (CONTINUATION)

This application is a continuation of U.S. Non-Provisional patent application Ser. No. 19/418,946, filed Dec. 13, 2025, titled “Systems and Methods for Biometric Continuity Token-Based Conversational Continuity Across Interfaced Computing Devices” (“Parent Application”), the entirety of which is incorporated herein by reference.

This application claims the benefit of priority to the following U.S. Provisional Patent Applications (as identified in the Parent Application), each incorporated by reference in its entirety for all purposes:
U.S. Provisional Application No. 63/930,668, filed Dec. 3, 2025
U.S. Provisional Application No. 63/930,661, filed Dec. 3, 2025
U.S. Provisional Application No. 63/921,315, filed Nov. 20, 2025
U.S. Provisional Application No. 63/914,032, filed Nov. 8, 2025
U.S. Provisional Application No. 63/913,268, filed Nov. 7, 2025
U.S. Provisional Application No. 63/913,146, filed Nov. 7, 2025

### STATEMENT REGARDING FEDERALLY SPONSORED RESEARCH

Not Applicable.

### SEQUENCE LISTING

NOT APPLICABLE.

### INCORPORATION BY REFERENCE/SPECIFICATION

The Specification of the Parent Application (U.S. Non-Provisional patent application Ser. No. 19/418,946, filed Dec. 13, 2025), including the Abstract, Background, Summary, Brief Description of Drawings, Detailed Description, and Drawings, is incorporated herein by reference in its entirety and reproduced below. This continuation filing is directed to a new claim set capturing the decentralized local accountless authorization gateway for monetization of continuity-based service access. The specification is identical to the Parent Application.

### FIELD OF THE INVENTION

The present disclosure relates generally to computer-implemented biometric security systems and continuity architectures and, more particularly, to systems and methods for maintaining persistent user-interactive session continuity across multiple computing interfaces through locally derived biometric or interaction-based identity tokens without reliance on centralized cloud identity services or persistent remote memory repositories.

### CROSS-REFERENCE TO RELATED APPLICATIONS

This application claims priority to the provisional applications identified in the “Cross-Reference to Related Applications” section above, each of which is incorporated herein by reference in its entirety.

### BACKGROUND OF THE INVENTION

Modern interactive computing platforms depend heavily on remote authentication servers, persistent cloud user accounts, centralized identity providers, and cloud-based memory repositories to maintain continuity of services and conversational state across devices. These architectures introduce substantial privacy risks, data leakage concerns, identity theft exposure, platform lock-in dependencies, jurisdictional regulatory conflicts, and service discontinuity failures during network outages, device transitions, or account deactivation events.

Existing biometric authentication systems typically require permanent storage of raw biometric identifiers or depend on centralized biometric comparison networks. These approaches introduce long-term privacy and security risks and make true user ownership of personal identity and continuity technically difficult or infeasible. Users must often trust external parties to retain, protect, and control access to deeply personal identity data.

Conversational and generative AI systems increasingly span heterogeneous platforms, including wearable devices, vehicles, robotic systems, entertainment systems, satellite terminals, mobile devices, and neural interface endpoints. However, current solutions provide no effective means of securely preserving conversational or contextual continuity across such platforms without remote tracking of user identity, persistent account structures, or cloud-stored memory repositories. The resulting architectures are highly centralized, network dependent, and vulnerable to single points of failure.

Prior art in related fields includes wearable-based health monitoring, biometric authentication devices, conversational AI orchestration, distributed transaction platforms, and low-latency communication systems. Such systems often depend on cloud-based processing, account-based identity, or centralized server coordination and do not disclose or suggest:
local, non-invertible biometric or interaction-signal-derived continuity tokens generated on a user-associated anchor device;
encrypted continuity memory stored solely under control of that anchor device;
offline restoration of conversational or interactive continuity across heterogeneous interface nodes without cloud-hosted identity profiles or remote memory; and
protocol-based, distributed continuity synchronization operating independently of centralized identity directories.

Accordingly, there remains a need for systems and methods capable of enabling seamless continuity of user interaction across diverse interfaces while preserving privacy through local identity derivation, eliminating reliance on persistent cloud identity architectures, enabling offline operational capability, and supporting both biometric and non-biometric continuity for human users and digital agents.

### SUMMARY OF THE INVENTION

The present disclosure provides systems and methods for maintaining persistent continuity of conversational or user-interactive computing sessions across multiple interfaced devices through the use of a continuity anchor device. The continuity anchor device acquires biometric or interaction-derived signals, derives anonymized non-invertible continuity tokens locally without permanent storage or transmission of raw biometric data, and indexes encrypted session context and continuity state data to the derived tokens.

By implementing continuity token derivation, encrypted session storage, and continuity restoration exclusively on the continuity anchor device without reliance on cloud identity services, the present disclosure improves computer system security and reliability, reduces network resource usage, and maintains interactive continuity during network and account outages.

In doing so, the disclosed systems and methods improve the functioning of computer-based interactive platforms by reducing reliance on centralized authentication servers, eliminating single points of failure in session continuity, and enabling secure state restoration even in the absence of network connectivity.

A locally encrypted memory store resident on or controlled by the continuity anchor device retains continuity state, conversational fragments, user preferences, and interaction metadata associated with the token. Upon re-detection of a valid token following interruption events such as disconnection, device handover, lapse of interaction, power cycling, idle periods, or interface transitions, a continuity restoration engine automatically restores session context without requiring network-based authentication, cloud data access, or persistent user account retrieval.

One or more conversational or user-interface nodes implemented across wearable devices, vehicles, robotic platforms, satellite terminals, mobile devices, audiovisual systems, fixed installations, neural interface endpoints, or cloud-hosted conversational systems exchange user-interactive data with the continuity anchor device. These nodes rely on ephemeral continuity token references and do not require persistent storage of personal identity records or biometric data.

The system may operate entirely locally or in decentralized and hybrid configurations, eliminating persistent cloud storage of biometric identifiers or user interaction memory. In other embodiments, the system implements a distributed continuity synchronization protocol defining continuity token message formats, cryptographically authenticated handshake sequences, reconciliation rules, and restoration priorities, enabling continuity synchronization across heterogeneous computing platforms and vendor ecosystems without centralized identity directories.

### BRIEF DESCRIPTION OF THE DRAWINGS

FIG. 1 illustrates a general system architecture showing a continuity anchor device interacting with multiple user-interface nodes through locally derived continuity tokens.

FIG. 2 illustrates a signal flow diagram depicting biometric or interaction-derived signal acquisition, token derivation, encrypted memory indexing, similarity matching, and continuity restoration across user-interface nodes without cloud dependency.

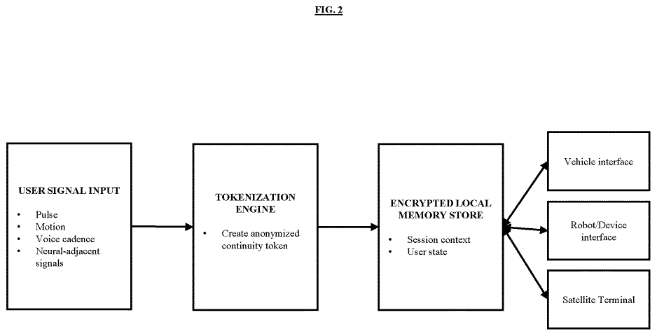

FIG. 3 illustrates an example neural-echo continuity flow showing passive buffering of non-semantic physiological or neural-adjacent signals during sleep or low-interaction states, correlation with waking user interactions, and generation of continuity assistance outputs.

### DETAILED DESCRIPTION OF EMBODIMENTS

The present disclosure provides a technological improvement to privacy-preserving session continuity systems by enabling secure cross-device state restoration without reliance on remote identity servers or persistent biometric storage.

### 6.0 Definitions

As used herein:
“Continuity token” refers to a non-invertible cryptographic value derived from one or more biometric or interaction-derived signals of a user (or digital persona) and a device-specific or environment-specific secret value, and used solely to index locally encrypted continuity state data without storing or transmitting raw biometric measurements.
“Neural-adjacent” signal denotes any physiological or electrical measurement obtained from a sensor positioned proximate to, but not penetrating, the user's skin or skull and processed only as numerical time-series data and statistical pattern signals, explicitly excluding any decoding or determination of specific thoughts, memories, or semantic mental content, and excluding any diagnosis or treatment of medical or mental health conditions.
“Non-semantic interpretation” means statistical or spectral analysis only—no word, memory, intent, or concept is extracted from the signals.
“Memory enhancement signal” refers to a non-verbal output, such as a vibration pattern, tone sequence, light signal, or brief cue, designed to reinforce recall without semantic content.
“Reflection pause” refers to a 0.5-3 second delay in response timing introduced by the system to simulate human thoughtfulness or deliberation.
“Continuity confidence threshold” refers to an acceptance metric, including but not limited to Hamming distance values, probabilistic similarity scoring, or vector distance calculations, used to determine whether two continuity tokens sufficiently correspond to authorize restoration of session context.
“Neural interface signal sensor” refers to any sensor capable of non-invasive acquisition of electrophysiological, electro-dermal, or neural-adjacent signals positioned proximate to the skin or cranial surface without penetrating tissue.
“Local authorization register” refers to a secure, device-resident memory record restricting continuity restoration or enhanced feature access to time-delimited intervals or specific usage conditions upon satisfaction of local cryptographic or biometric authorization conditions.
“Safety governance layer” refers to a software, firmware, or hardware module configured to monitor biometric indicators, user consent, and device tamper conditions and to control memory storage, erasure, authorization state, and continuity restoration according to predefined safety and privacy rules.
“Behavioral modulation engine” refers to a processing module configured to adapt system response timing, interaction cadence, or presentation characteristics based on biometric or interaction-derived measurements to better align with user behavior or preferences.
“Docking interface” refers to a physical and/or electrical interface configured to provide secure, time-limited communication between the continuity anchor device and an external device or station for authentication, diagnostics, firmware updating, or controlled data access.
“Continuity anchor device” refers to a user-associated computing device or secure virtual environment configured to acquire biometric or interaction-derived signals from a user or digital persona and locally execute continuity token derivation, encrypted memory indexing, similarity matching, continuity restoration, cryptographic authorization, and safety-governance operations, the continuity anchor device being implemented in some embodiments as a wearable computing device and in other embodiments as a mobile terminal, headset, vehicle-integrated module, robotic interface node, neural interface endpoint, trusted execution environment, or other user-associated computing platform.
“Non-transitory computer-readable medium” refers to any non-transitory data storage device, including but not limited to random-access memory (RAM), read-only memory (ROM), flash memory, magnetic storage media, or optical disks, and explicitly excludes transitory propagating signals or carrier waves.

### 6.1 System Architecture

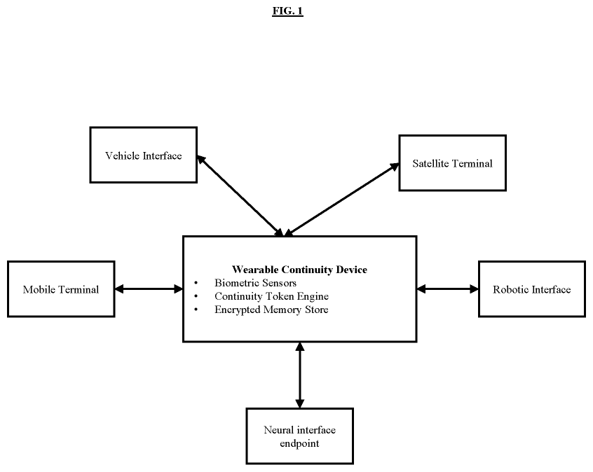

As shown in FIG. 1, the system comprises a continuity anchor device associated with a user. In many embodiments, the continuity anchor device is implemented as a wearable device such as a pendant, bracelet, ring, or head-mounted unit. In other embodiments, the continuity anchor device is implemented as a mobile terminal, vehicle-integrated console, neural interface gateway, robotic node, or other form factor.

The continuity anchor device includes one or more biometric or interaction-derived sensors, such as:
pulse or heart rate sensors;
thermal or skin temperature sensors;
inertial measurement units, accelerometers, or gyroscopes;
electro-dermal or galvanic skin response sensors;
neural-adjacent electrophysiological sensors;
microphones or vocal cadence analyzers;
capacitive, touch, or typing rhythm sensors;
gaze, motion, or additional interaction pattern detectors.

The continuity anchor device executes an identity derivation engine that processes raw sensor data locally to generate a continuity token. This token represents an anonymized biometric or interaction profile. Raw biometric identifiers and feature vectors need not be stored in non-volatile memory, nor transmitted outside the continuity anchor device.

A locally encrypted memory store within or under the control of the continuity anchor device indexes conversational state, session context, user preferences, conversation history fragments, continuity metadata, or other user-interactive information to the continuity token. The encrypted memory store may be implemented using symmetric or asymmetric cryptography and may rely on secure enclaves or trusted execution hardware.

Example: In a vehicular use case, the continuity anchor device (worn as a pendant or integrated into the steering column) detects pulse and motion signals while the user is driving, derives a continuity token, and stores a conversation about navigation preferences, calendar entries, and entertainment selections keyed to the token. Upon the user's arrival home, the same continuity anchor device interacts with a domestic robotic system; the robotic system receives continuity cues from the anchor device and restores the preferences and conversation context seamlessly.

### 6.2 Continuity Restoration

Upon reconnection of the continuity anchor device to any conversational user-interface node, the identity derivation engine acquires fresh biometric or interaction-derived signals and determines whether a previously derived continuity token has been re-detected following one or more interruption events, including:
device transitions;
power loss or reboot;
network interruptions;
idle periods or lapse of user interaction;
removal and re-association of the continuity anchor device with the user.

Upon successful token recognition, the continuity restoration engine retrieves associated session state and re-establishes the contextual conversational environment without requiring network authentication, credential entry, or cloud retrieval of stored memory. Restoration may include resuming a prior dialog, reinstating user-specific preferences, or reconstituting the last known interaction state.

Example: After a two-hour idle period, the continuity anchor device re-detects the continuity token upon sensing a valid live-user biometric pattern and restores a conversation on a mobile terminal, optionally adjusting response latency to match the user's recent typing rhythm.

### 6.3 Conversational User-Interface Nodes

As shown in FIG. 1, conversational user-interface nodes may operate on any computing platform capable of exchanging user-interactive data with the continuity anchor device, including but not limited to:
wearable devices;
vehicles and autonomous transport platforms;
robotic systems or assistive robotics;
mobile terminals or phones;
fixed installations, kiosks, or retail terminals;
entertainment systems or audiovisual terminals;
satellite communication terminals or spacecraft consoles;
head-mounted displays or spatial projection systems;
neural interface endpoints;
cloud-hosted conversational or AI services.

These nodes do not persist long-term personal identity data and rely solely on ephemeral continuity tokens or token references exchanged locally with the continuity anchor device to obtain continuity context. Session data may be streamed from the continuity anchor device or reconstructed based on state information supplied by the continuity anchor device.

Example: In a vehicle-to-robot transition, the continuity anchor device hands off an ongoing conversation about daily tasks from the car's infotainment system to a home robotic assistant without transmitting raw biometric data to either system.

### 6.4 Token Derivation and Encryption

The continuity token is generated using local cryptographic derivation mechanisms incorporating:
biometric or interaction signal preprocessing and normalization;
statistical entropy quantization or feature extraction;
rolling feature vector construction over sliding windows;
cryptographic hashing functions, such as SHA-256 or similar primitives.

Tokens are transient, revocable, and non-invertible, ensuring that personally identifiable biometric or neural signals cannot be reconstructed from the stored continuity data. The continuity anchor device may rotate or refresh continuity tokens periodically or in response to security events.

The encrypted memory store uses symmetric or asymmetric cryptographic encryption to prevent unauthorized extraction of session or identity contextual data. Neither raw biometric data nor full feature vectors are stored in non-volatile memory or transmitted externally. In some embodiments, only truncated token indices and encrypted session payloads are stored.

### 6.4.1 Example Token Generation Algorithm

In one embodiment, the identity derivation engine samples pulse rate and motion data at predetermined sampling frequencies. Pulse rate is sampled at 32-128 Hz and motion from a three-axis accelerometer is sampled at 50-200 Hz. The engine computes, over a sliding time window of 5-20 seconds, a biometric feature vector comprising at least:
(i) an average pulse rate;
(ii) a pulse rate variance;
(iii) an average acceleration magnitude; and
(iv) an acceleration variance.

Each feature is normalized into a bounded numeric range and quantized into a fixed number of bits (for example, 8-12 bits per dimension). The quantized values are concatenated into a feature string and combined with a device-specific secret value stored in a secure enclave. A cryptographic hashing function, such as SHA-256, is applied to the concatenated feature string and device secret to produce a digest. A subset of the digest bits (for example, 128 bits) is used as the continuity token. The token is non-invertible with respect to the underlying biometric measurements. 6.4.1.1 Worked Example—Continuity Token Generation and Matching

In one illustrative example:
A pulse sensor reports heart rate samples with an average of 72.4 bpm and variance of 4.1.
A three-axis accelerometer reports motion magnitudes averaging 0.032 g with variance of 0.009.

The identity derivation engine forms a feature vector F=[72.4, 4.1, 0.032, 0.009] and normalizes it to a bounded interval, yielding F′. Each component is quantized into fixed-bit integer representation Q. The quantized values are concatenated into a feature string S. S is concatenated with a device-specific secret D stored in a secure enclave, resulting in X.

A cryptographic hash H=SHA256(X) is computed, and a predetermined subset of bits is truncated to produce the continuity token T. Upon subsequent operation, new biometric samples produce a re-derived vector yielding a second token T′. A token comparison module computes the Hamming distance HD(T, T′) between T and T′. If HD(T, T′) is less than or equal to a threshold (e.g., 10 bits out of 128 bits), the tokens are considered matched and the continuity confidence threshold is satisfied. The indexed continuity state data may then be retrieved from the encrypted local memory store to restore the user session. If the threshold is not satisfied, continuity restoration is denied.

This process ensures robustness to transient biometric fluctuations while preventing reconstruction of underlying biometric measurements from the continuity token.

In informal prototype testing conducted entirely offline using pulse-rate and motion-derived signals, the continuity token system consistently exceeded a same-user matching rate of zero point nine five across repeated sessions, with low false acceptance, without reliance on any network connectivity or centralized identity service.

### 6.4.2 Example Token Matching

When a new continuity token is generated, a token comparison module computes a similarity metric between the new token and one or more previously stored reference tokens. In one embodiment, the similarity metric is a Hamming distance between token bit strings. In other embodiments, similarity may be computed using correlation coefficients, Euclidean or cosine distance in an embedding space, or probabilistic matching.

If the similarity metric between the new token and a stored reference token satisfies the continuity confidence threshold, the system treats the tokens as a match and authorizes retrieval of associated session context. If the similarity metric does not satisfy the threshold for any stored token, continuity restoration is denied, and no session context is loaded.

### 6.4.3 Continuity State Machine Operation

In some embodiments, continuity management is performed using a multi-state execution model. The system operates according to the following states:
1. Enrollment State—the continuity anchor device acquires biometric or interaction-derived signals and generates an initial continuity token associated with a new encrypted session memory entry.
2. Active Continuity State—the system continuously refreshes token derivation for ongoing session verification and may update encrypted session context incrementally.
3. Matching State—upon reconnection, idle interruption, or interface transition, the continuity anchor device computes a re-derived continuity token and compares it to stored tokens using similarity metrics.
4. Authorization State—if confidence thresholds are met, associated session context is restored or partially restored.
5. Revocation State—if mismatch or tamper detection occurs, the associated continuity token and its indexed memory state are invalidated and optionally erased.
6. Re-Enrollment State—upon user consent or security reset, new continuity tokens are generated and continuity resumes.

This state-machine logic is executed locally on the continuity anchor device without reliance on centralized servers or cloud identity services.

A pseudocode representation:
WHILE system_active:
   SAMPLES←acquire_sensor_window( )
   F←normalize_features(SAMPLES)
   Q←quantize(F)
   X←concat(Q, device_secret)
   TOKEN_new←hash(X)
   IF stored_tokens empty THEN
      store(TOKEN_new, session_state)
      state←ACTIVE
   ELSE
      match_found←FALSE
      FOR each TOKEN_old in stored_tokens:
         IF HAMMING(TOKEN_new, TOKEN_old)<=threshold THEN
         restore_session(TOKEN_old)
         state←AUTHORIZED
         match_found←TRUE
         BREAK
      IF NOT match_found THEN
         deny_continuity( )
         state←REVOKE
END WHILE

### 6.5 Offline Operation

The continuity anchor device and user-interface nodes may function independently of persistent network connectivity. All continuity restoration operations can be executed locally or via direct device-to-device communication mechanisms without cloud dependency.

The system can operate indefinitely in offline mode while still providing continuity restoration based solely on locally stored tokens and encrypted memory. Continuity assistance cues, such as subtle prompts or memory reinforcement signals, do not generate any persistent data outside the continuity anchor device, reinforcing privacy guarantees.

Example: In a remote area without network coverage, the continuity anchor device restores a session from local memory upon reboot and resumes interaction with a nearby offline terminal.

### 6.6 Additional Embodiments—Cognitive Continuity and Liveness Verification

### 6.6.1 Neural Echo/Passive Cognitive Continuity

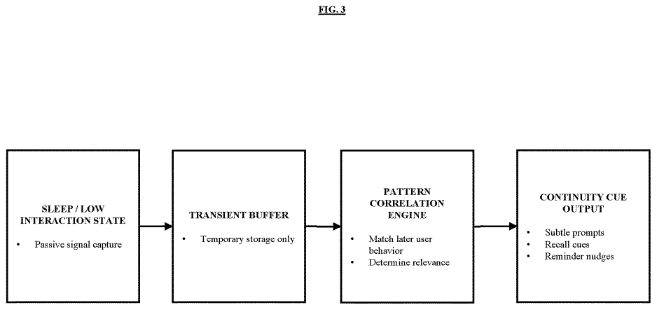

In some embodiments illustrated in FIG. 3, the continuity anchor device may passively detect non-semantic physiological or neural-adjacent signal patterns during periods of reduced interaction or sleep states.

Such signals are:
temporarily buffered in local volatile memory;
summarized into non-semantic statistical measures;
not semantically interpreted or decoded;
not transmitted to any remote system.

Upon subsequent waking interactions, current user activity patterns may be correlated with buffered activity signatures to determine potential contextual relevance. When a correlation threshold is satisfied, the system may generate non-explicit continuity assistance outputs selected from:
subtle prompts;
recall-reinforcement cues;
memory enhancement signals;
nudge notifications.

These outputs do not constitute interpretation of dream content or direct decoding of user thoughts, but serve solely to reinforce continuity between subconscious activity and waking task completion.

In one embodiment, the continuity anchor device samples physiological signals such as heart rate variability and skin conductance at a low sampling frequency (e.g., 0.5-4 Hz) during periods when the user is detected as inactive or sleeping. The sampled values are stored in a circular buffer representing a rolling time window (e.g., 30-90 minutes) and are periodically summarized into numerical statistics. Upon detection of waking interaction, the system computes similarity metrics between the summarized physiological statistics and recent interaction patterns; if a threshold level of correlation is detected, the system triggers a predetermined cue pattern (such as a brief vibration or tone) associated with a previously stored task reminder.

At no point are the buffered physiological signals transformed into decoded semantic content or used for medical analysis.

### 6.6.2 Liveness and Anti-Spoofing Verification

In some embodiments, the continuity anchor device applies liveness validation to ensure continuity authorization is based on genuine live-user biometric sampling rather than spoof replication. Liveness measures may include:
challenge-response testing of pulse-rate variability over randomized sampling windows;
sensor fusion cross-validation between pulse, motion, thermal, and electro-dermal signals to detect physiological coherence;
detection of temporal anomalies inconsistent with continuous biological signal generation;
detection of static or replayed signal patterns indicative of recording attacks.

If spoofing or replay patterns are detected, continuity matching is denied, revocation protocols are initiated, and memory entries may be invalidated or erased according to safety policies.

### 6.7 Privacy and Data Control

No personally identifiable biometric data, raw neural recordings, dream content, or unprocessed sensor streams are stored permanently or transmitted externally. All continuity tokens, buffers, memory indexing, and continuity restoration operations are executed locally under control of the continuity anchor device.

User memory may be selectively retained, erased, or purged based on user preferences, inactivity thresholds, or regulatory requirements. No cloud-based biometric identity storage or centralized session continuity servers are required.

### 6.8 Security and Tamper Protection

The continuity anchor device can include tamper detection circuits, encrypted secure enclaves, write-once memory fusing mechanisms, and hardware integrity checks configured to trigger cryptographic erasure of stored continuity keys, encrypted memory data, and associated continuity tokens upon detection of unauthorized access attempts or tampering.

In docking-enabled embodiments, any external docking station or host device participating in controlled data access is further configured to cryptographically erase temporary session keys, cached continuity data, and authentication credentials upon termination of the session, ensuring that no user memory, continuity state, or biometric-derived data remains accessible outside the continuity anchor device. All such security and tamper protection operations are executed locally and do not depend on network connectivity or cloud services.

### 6.9 Commercial and Software Integration

The system may operate with local transaction authorization mechanisms in which micro-transaction or local access triggers initiate temporary enhanced continuity features or session privileges without dependency on centralized accounts, remote identity servers, or cloud-based validation. In payment-enabled embodiments, the continuity anchor device generates transaction authorization requests, verifies cryptographic receipts or zero-knowledge proofs, and updates a local time-locked authorization register.

Transactions are generated, validated, and recorded locally. Authorization updates are written exclusively to the local authorization register tied to the continuity token. Variable transaction parameters may include session duration, feature access, or other operational enhancements defined by local policy modules. No raw biometric data, detailed continuity state, or network-based identity information is transmitted externally for monetization. Transactions do not rely on network communication for validation, supporting fully offline operation.

Reflection pauses between 0.5 and 3 seconds may be applied to responses to simulate human thoughtfulness, enhance perceived quality, and avoid masking latency. These local transaction authorization mechanisms function independently of biometric identity derivation and remain subordinate to the privacy and safety protections described herein.

### 6.9.1 Micro-Transaction Validation Protocol

In embodiments supporting micro-transactions or local access unlocks, the transaction-based access control module executes a cryptographic validation protocol independent of cloud identity systems. A representative flow includes:
Step A: The continuity anchor device generates a locally issued transaction request containing a time stamp, session continuity token hash reference, feature unlock identifier, and transaction request parameters based on local policy.
Step B: A local or optionally connected payment processing subsystem returns a cryptographic payment confirmation receipt including a transaction validation signature or proof.
Step C: The continuity anchor device validates the receipt using signature verification or zero-knowledge proof techniques without exposure of raw biometric data or full continuity tokens.
Step D: Upon validation, the continuity restoration engine updates a local time-locked authorization register to permit enhanced session functionality or extended access intervals.
Step E: All transaction generation, validation, and authorization operations are executed locally; no continuity state, raw biometric data, or user memory is transmitted externally.

### 6.10 Clinical Disclaimer

The disclosed system does not provide medical diagnosis, mental health evaluation, dream interpretation, or neural therapeutic treatment. Neural-adjacent detection serves only as a passive contextual continuity support mechanism and does not decode neurological content or cognitive intent.

### 6.11 Policy-Adaptive Continuity Operation

In certain embodiments, the biometric continuity token system applies one or more jurisdictional, enterprise, or regulatory policy profiles that dynamically govern the operation of continuity token processing, session state retention, authorization verification, or metadata disclosure behaviors.

Policy profiles may specify that continuity operations execute in one or more selectable compliance modes including:
a) a fully private local-operation mode in which continuity tokens and session memory are generated, stored, matched, and erased exclusively on the continuity anchor device without any external reporting of continuity state or metadata;
b) a regulated compliance mode in which a subset of cryptographically verifiable session metadata or authorization records are escrowed, encrypted, or transmitted to a designated compliance validation endpoint without exposure of raw biometric signals, neural-adjacent signals, or personal interaction content; and
c) a hybrid operation mode in which token derivation and session continuity remain local while authorization or audit confirmation receipts are periodically synchronized to compliance infrastructure systems according to jurisdictional or enterprise rules.

Selection or switching of policy profiles may be configured automatically based on device geolocation, regulatory instruction broadcasts, enterprise security directives, or user-authorized overrides. In all cases, the continuity token derivation, encrypted memory indexing, similarity-matching algorithms, and restoration logic remain locally executed on the continuity anchor device, ensuring that core continuity capabilities operate independently of centralized identity control.

### 6.12 Protocol-Based Continuity Synchronization

In certain embodiments, the system implements a distributed continuity synchronization protocol defining structured message formats, cryptographic continuity token references, handshake sequences, reconciliation rules, and state restoration ordering logic for transferring and synchronizing user or agent interaction context across heterogeneous computing platforms.

The protocol governs:
transmission of continuity token references or cryptographic hashes between user-interface nodes and the continuity anchor device;
cryptographically authenticated session-state reconciliation requests and acknowledgments;
conflict resolution handling between partial or concurrent interaction streams originating from different interface nodes;
session restoration staging for continuation of conversational flow following device transitions or network interruptions.

The protocol operates independently of any single interface platform and may be implemented within hardware, firmware, software applications, or virtualized environments across devices operated by differing vendor ecosystems or ownership domains. Protocol execution does not require shared persistent user accounts or centralized identity directories.

### 6.13 Digital Persona and Autonomous Agent Continuity

In certain embodiments, continuity tokens may be derived not only from biometric or interaction-derived human signal sources but additionally from digital persona signatures, behavioral interaction profiles, or autonomous agent state fingerprints representing persistent conversational or operational identities of non-human or semi-autonomous entities.

Accordingly, the continuity system supports session continuity not only between computing platforms associated with human users, but also between interacting digital agents, co-piloting assistants, virtual personas, or neural-simulation-derived identity constructs wherein continuity identification is established via cryptographically derived interaction-state signatures rather than biological anchoring.

The encrypted memory indexing and continuity restoration engines process such persona-derived continuity tokens using the same similarity metrics and threshold confidence mechanisms to preserve persistent conversational context across computing platforms for both human and non-human identity entities.

### 6.14 Hardware-Neutral Anchor Implementations

In certain embodiments, the continuity anchor device may be implemented as a physical wearable apparatus, mobile terminal, implanted computing module, vehicle-integrated computing environment, robotic subsystem node, neural interface gateway, distributed trusted execution container, or fully virtualized cryptographic persona environment.

Such implementations encompass both dedicated hardware anchors and software-instantiated anchors operating within secure enclaves, trusted execution environments, containerized compute nodes, peer-to-peer mesh routers, or ledger-bound cryptographic entities. In all embodiments, the continuity token generation, encrypted memory indexing, similarity matching, authorization updating, and restoration logic remain functionally equivalent, independent of physical or virtual embodiment.

### ALTERNATIVE EMBODIMENTS

The present disclosure may be implemented across a wide range of hardware and software substrates including but not limited to:
wearable pendants, bracelets, rings, or head-mounted devices;
implanted computing modules or medical-grade devices;
hybrid biometric authentication accessories;
vehicle-mounted biometric terminals and infotainment systems;
robotic interface relays and home automation hubs;
satellite uplink identity modules and spaceborne computing systems;
secure virtualization containers or distributed ledger-anchored identities.

Communication methods may include wired ports, wireless RF links, Bluetooth Low Energy (BLE) communications, satellite uplinks, optical transceivers, bio-electrical couplings, or other physical or wireless channels.

Cryptographic derivation algorithms may include but are not limited to hashing, rolling entropy derivation, zero-knowledge proof tokenization, homomorphic encryption-assisted comparisons, or secure enclave-processed biometric transformations.

### CONCLUSION

The present disclosure enables secure and privacy-preserving continuity of interactive computing sessions across distributed devices without dependence on centralized cloud identity infrastructures or storage of personal biometric identifiers. By employing local continuity token derivation, encrypted local memory indexing, offline-capable continuity restoration, and protocol-based synchronization, the disclosed technology advances the state of biometric and interaction-based continuity computing systems for both human and digital personas.

1. A decentralized authorization system for regulating continuity-based service access across heterogeneous user-interface nodes, comprising:
a) a continuity anchor device configured to be physically associated with a user or instantiated within a trusted execution environment and including one or more biometric or interaction-derived signal sensors;
b) an identity derivation engine implemented by one or more processors of the continuity anchor device and configured to derive a continuity token from one or more biometric or interaction-derived signals combined with a device-specific or environment-specific secret value, the continuity token being non-invertible with respect to the underlying signals;
c) an encrypted local memory store within or under control of the continuity anchor device and configured to retain session context data indexed to the continuity token;
d) a local authorization register maintained by the continuity anchor device and configured to store a time-locked authorization state governing access to one or more enhanced continuity service features comprising at least one of session duration extension, continuity memory depth allocation, processing cadence parameter, continuity persistence, or cross-device restoration privilege;
e) one or more processors of the continuity anchor device configured to generate a local authorization request referencing at least one cryptographic derivative of the continuity token and one or more service access parameters;
f) one or more processors of the continuity anchor device configured to validate a cryptographic authorization receipt or zero-knowledge proof locally using locally stored cryptographic key material of the continuity anchor device, the receipt being cryptographically bound to (i) at least one cryptographic derivative of the continuity token and (ii) at least one of a timestamp, a feature unlock identifier, or transaction request parameters; and
g) one or more processors of the continuity anchor device configured to update the local authorization register to enable or disable the enhanced continuity service features responsive to successful local validation of the cryptographic authorization receipt or zero-knowledge proof,
wherein persistent centralized user accounts and cloud-hosted entitlement validation are not required as a prerequisite to enabling continuity-based service access, and wherein continuity restoration is conditioned on a similarity metric that satisfies a predefined continuity confidence threshold evaluated locally at the continuity anchor device, and
wherein any remote account login, cloud-hosted entitlement validation, federated identity assertion, or external authorization event is insufficient by itself to authorize continuity-based service access absent local validation within the continuity anchor device.

2. The system of claim 1, wherein continuous network connectivity is not required as a prerequisite to generating the local authorization request, validating the cryptographic authorization receipt, or updating the local authorization register.

3. The system of claim 1, wherein the cryptographic derivative of the continuity token comprises a cryptographic hash reference of the continuity token.

4. The system of claim 1, wherein the local authorization request includes a timestamp, a feature unlock identifier, and transaction request parameters, and wherein the cryptographic authorization receipt is cryptographically bound to at least the timestamp and the feature unlock identifier.

5. The system of claim 1, wherein the service access parameters comprise at least one of a session duration extension, a continuity memory depth allocation, a processing cadence parameter, continuity persistence, or a cross-device restoration privilege.

6. The system of claim 1, wherein the one or more processors are further configured to compute authorization request values based on locally evaluated policy parameters independent of centralized account pricing tables or remote economic systems.

7. The system of claim 1, wherein the one or more processors are further configured to automatically enforce expiration of the time-locked authorization state based on an expiry timestamp or time-to-live value stored in the local authorization register, and to re-lock enhanced continuity service features upon expiration.

8. The system of claim 1, wherein the one or more processors are further configured to transmit, to at least one heterogeneous user-interface node, an authorization status indicator or a cryptographic authorization receipt corresponding to the local authorization request, without transmitting raw biometric signals or continuity token source measurements.

9. The system of claim 1, wherein the continuity token is derivable from at least one of a hardware-bound cryptographic credential of the continuity anchor device or secure enclave key material of the continuity anchor device, such that continuity restoration is authorizable without deriving the continuity token from biometric signals.

10. The system of claim 1, further comprising a safety governance layer configured to override the time-locked authorization state by suspending enhanced continuity service features or initiating cryptographic erasure of session context data upon detection of a tamper condition or a user-issued erasure command.

11. The system of claim 1, wherein the local authorization register is stored locally within or under exclusive cryptographic control of the continuity anchor device such that the time-locked authorization state is not reconstructible or enforceable absent locally stored cryptographic key material of the continuity anchor device.

12. The system of claim 1, wherein the one or more processors are further configured to prevent disclosure of raw biometric signals, raw interaction feature vectors, or continuity token source measurements outside the continuity anchor device during authorization.

13. The system of claim 1, wherein the continuity anchor device operates under dynamically selectable policy profiles comprising at least a private local-operation mode, a regulated compliance mode, and a hybrid operation mode, wherein continuity token derivation, similarity matching, and local authorization register updates remain locally executed regardless of the selected policy profile.

14. The system of claim 1, wherein the continuity token is further derivable from at least one of digital persona signatures, behavioral interaction profiles, or autonomous agent state fingerprints, enabling service access authorization for both human users and non-human digital identity entities.

15. The system of claim 1, wherein the predefined continuity confidence threshold comprises a maximum Hamming distance acceptance value evaluated between bit strings of a re-derived continuity token and a stored reference continuity token.

16. The system of claim 1, wherein locally stored cryptographic key material used for validating the cryptographic authorization receipt or zero-knowledge proof is stored in a secure enclave or trusted execution hardware of the continuity anchor device and is not extractable outside the enclave boundary.

17. The system of claim 1, wherein tamper detection circuitry of the continuity anchor device is configured to initiate cryptographic erasure of the local authorization register and invalidation of the time-locked authorization state upon detection of a tamper condition, regardless of any active time-locked authorization state.

18. The system of claim 1, wherein the safety governance layer is configured to supersede the time-locked authorization state by cryptographically erasing the local authorization register upon detection of a predefined safety event, regardless of any active time-locked authorization state.

19. A computer-implemented method for regulating continuity-based service access at a continuity anchor device, the method comprising:
a) deriving, at the continuity anchor device, a continuity token from one or more biometric or interaction-derived signals combined with a device-specific or environment-specific secret value, the continuity token being non-invertible with respect to the underlying signals;
b) generating a local authorization request referencing at least one cryptographic derivative of the continuity token and one or more service access parameters;
c) validating a cryptographic authorization receipt or zero-knowledge proof locally at the continuity anchor device using locally stored cryptographic key material of the continuity anchor device, the receipt being cryptographically bound to (i) at least one cryptographic derivative of the continuity token and (ii) at least one of a timestamp, a feature unlock identifier, or transaction request parameters;
d) updating a local authorization register to store a time-locked authorization state enabling one or more enhanced continuity service features responsive to successful local validation; and
e) restoring session continuity upon re-detection of a continuity token for which a similarity metric satisfies a predefined continuity confidence threshold following an interruption event, without requiring persistent centralized user accounts or cloud-hosted entitlement validation, and wherein any remote account login, cloud-hosted entitlement validation, federated identity assertion, or external authorization event is insufficient by itself to authorize continuity-based service access absent local validation within the continuity anchor device.

20. The method of claim 19, wherein continuous network connectivity is not required as a prerequisite to performing any step of the method.

21. The method of claim 19, further comprising automatically enforcing expiration of the time-locked authorization state and re-locking enhanced continuity service features upon expiration.

22. The method of claim 19, further comprising transmitting, to at least one heterogeneous user-interface node, an authorization status indicator or a cryptographic authorization receipt corresponding to the local authorization request, without transmitting raw biometric signals or continuity token source measurements.

23. The method of claim 19, further comprising operating under a selectable policy profile comprising at least one of a private local-operation mode, a regulated compliance mode, or a hybrid operation mode that governs external disclosure of authorization metadata while maintaining local continuity token derivation and local authorization register updates.

24. A non-transitory computer-readable medium storing machine-executable instructions that, when executed by one or more processors of a continuity anchor device, cause the continuity anchor device to:
a) derive a continuity token from one or more biometric or interaction-derived signals combined with a device-specific or environment-specific secret value, the continuity token being non-invertible with respect to the underlying signals;
b) retain session context data in an encrypted local memory store indexed to the continuity token;
c) generate a local authorization request referencing at least one cryptographic derivative of the continuity token and one or more service access parameters;
d) validate a cryptographic authorization receipt or zero-knowledge proof locally using locally stored cryptographic key material of the continuity anchor device, the receipt being cryptographically bound to (i) at least one cryptographic derivative of the continuity token and (ii) at least one of a timestamp, a feature unlock identifier, or transaction request parameters;
e) update a local authorization register to store a time-locked authorization state enabling one or more enhanced continuity service features responsive to successful local validation; and
f) upon re-detection of a continuity token for which a similarity metric satisfies a predefined continuity confidence threshold following an interruption event, restore session context data without requiring persistent centralized user accounts or cloud-hosted entitlement validation, wherein any remote account login, cloud-hosted entitlement validation, federated identity assertion, or external authorization event is insufficient by itself to authorize continuity-based service access absent local validation within the continuity anchor device.

25. The non-transitory computer-readable medium of claim 24, wherein the instructions further cause the continuity anchor device to automatically enforce expiration of the time-locked authorization state and re-lock enhanced continuity service features upon expiration.

26. The non-transitory computer-readable medium of claim 24, wherein the instructions further cause the continuity anchor device to derive continuity tokens additionally from at least one of digital persona signatures, behavioral interaction profiles, or autonomous agent state fingerprints, enabling service access authorization for both human users and digital agents.

27. The system of claim 1, wherein all authorization request generation, cryptographic receipt validation, and local authorization register updates are performed locally at the continuity anchor device without reliance on any remote authorization server.

28. The system of claim 1, wherein the cryptographic authorization receipt is bound to both (i) a cryptographic derivative of the continuity token and (ii) a timestamp and feature unlock identifier such that replay of the receipt is rejected.

29. The system of claim 1, wherein the local authorization register is exclusively controlled by cryptographic key material stored within a secure enclave of the continuity anchor device such that the authorization state is not modifiable by any external system, remote service, or software layer executing outside the secure enclave.

30. The system of claim 1, wherein authorization of enhanced continuity service features is performed without reliance on any persistent user account identifier, such that the authorization is tied exclusively to the locally derived continuity token and locally validated cryptographic authorization receipt.
